(19) United States
(12) Patent Application Publication
(10) Pub. No.: US 2025/0223987 A1
(43) Pub. Date: Jul. 10, 2025

(54) CONSTRUCTIVE ARRANGEMENT APPLIED TO A SUPPORT FOR REINFORCEMENT OF FURNITURE LEGS

(71) Applicant: Eduardo Ernesto BAZHUNI MAIA, RIO DE JANEIRO (BR)

(72) Inventor: Eduardo Ernesto BAZHUNI MAIA, RIO DE JANEIRO (BR)

(21) Appl. No.: 18/976,580

(22) Filed: Dec. 11, 2024

(30) Foreign Application Priority Data
Jan. 8, 2024 (BR) 2020240003263

(51) Int. Cl. F16B 12/44; A47B 13/02; A47C 7/00; A47C 19/02

(52) U.S. Cl. CPC F16B 12/44; A47B 13/02; A47C 7/002; A47C 19/024; F16B 2012/446

(57) ABSTRACT

A reinforcement support for the legs of furniture pieces such as chairs, beds, tables, cabinets, shelves, among others, to provide greater strength to the legs of the piece of furniture, resulting in a longer useful life of the piece and in the reduction of much of the instability, providing greater safety for the user. The constructive arrangement of the present model comprises a support preferably with a square-shaped structure, which is fitted to the legs of the furniture to provide reinforcement to the legs and ensure that the same do not wobble when weight is applied to the furniture. The support is fitted to the legs of the piece of furniture preferably by using fastening element applied to the fitting sleeves located at the vertices of the structure of the support, which guarantees the stability of the piece of furniture.

### CROSS REFERENCE TO RELATED APPLICATIONS

This application claims the benefit of priority from Brazilian Patent Application No. 2020240003263, filed Jan. 8, 2024, the disclosure of which is incorporated herein by reference.

### TECHNICAL FIELD

The present model falls within the field of furniture in general. Specifically, the present model refers to a support to be fitted to the legs of various pieces of furniture with the aim of bringing improvements and advantages to the use of furniture in general.

### BACKGROUND OF THE INVENTION

A piece of furniture can be defined as a set of furniture intended for use and decoration in a home, office, hotel, school or any other establishment. Among the pieces of furniture, there can be mentioned as examples, chairs, beds, tables, cabinets, shelves, among others, in which the rest and support of the piece against the floor is provided by means of legs.

However, depending on the material the piece of furniture is made of and also as a result of the weight applied to the piece and the time it is used, it is possible for the piece of furniture to become unstable, especially in its legs, causing the same to wobble during use.

In some cases, depending on the weight applied to the piece of furniture, the structure of the piece may even collapse, posing risks to the integrity of the users.

In this way, it is necessary to apply a reinforcement support to the legs of pieces of furniture, in order to provide greater strength to the legs of the piece, resulting in a longer useful life of the piece of furniture and in the reduction of much of the instability, providing greater safety for the user.

### STATE OF THE ART

Some documents in the state of the art disclose technologies that fall within the same field as the present utility model, in which, however, no constructive arrangements similar to those of the present utility model are observed.

Document CN219755010 discloses a reinforcing structure for tables and chairs wherein a connecting piece for assembling table and chair legs comprises connecting plates that are symmetrically fastened on the table or chair legs, so that the service life of the table and chair is prolonged and the stability of the table and chair is improved. The document discloses that by tightening and fastening the first fastening screw and the second fastening screw, the stability of the table and chair in use can be further improved, thereby extending their service life.

Document TWM64155 discloses a reinforcing structure of table legs, which includes: a table plate, a plurality of table legs, a plurality of reinforcing pieces, and a cross beam. Each table leg assembly is arranged below the table plate and has a rotating portion with a connecting portion for two table legs, and the inner surface of each table leg has an installation groove communicating with the rotating portion. The document discloses that each reinforcement piece is embedded in the installation groove of each table leg, and each reinforcement piece has a protruding reinforcement piece assembly portion corresponding to the assembly portion of the two table legs. The two ends of the cross beam have two assembly slopes corresponding to the rotating parts of each table leg, with the two assembly slopes corresponding to the two assembly pieces of the table legs and the assembly piece of the reinforcement piece, resulting in greater stability.

Although the listed documents of the state of the art disclose reinforcement elements applied to the furniture legs, none of the documents present a solution as described by the arrangement applied in the present utility model.

### BRIEF DESCRIPTION OF THE INVENTION

The present model aims at providing a reinforcement support for legs of furniture pieces such as chairs, beds, tables, cabinets, shelves, among others, in order to provide greater strength to the legs of the piece, resulting in a longer useful life of the piece of furniture and in the reduction of much of the instability, providing greater safety for the user.

The constructive arrangement of the present model comprises a support preferably with a square-shaped structure, which is fitted to the furniture legs in order to provide reinforcement to the legs and ensure that the same do not wobble when weight is applied to the furniture. The support is fitted to the furniture legs by simply inserting the furniture legs into the fitting sleeves of the support located at each of the vertices of the structure of the support, but such a fitting can also be done by using fastening means applied to the fitting sleeves.

### BRIEF DESCRIPTION OF THE FIGURES

In order to help identify the main features of the model, the figures to which references are made are presented as follows:

FIG. 1 is an illustration in top perspective of a piece of furniture with the support for reinforcing furniture legs applied.

FIG. 2 is an illustration in bottom perspective of a piece of furniture with the support for reinforcing furniture legs applied.

FIG. 3 is an illustration in top perspective of the support for reinforcing furniture legs.

FIG. 4 is an illustration in bottom perspective of the support for reinforcing furniture legs.

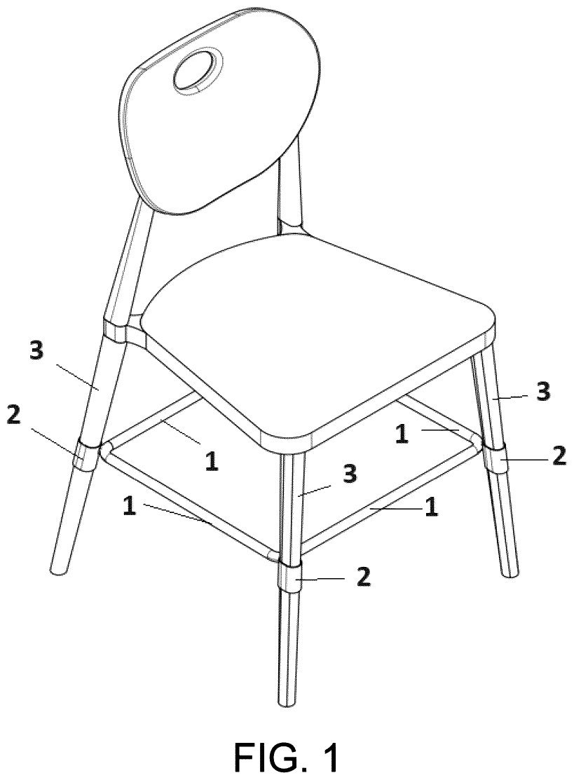

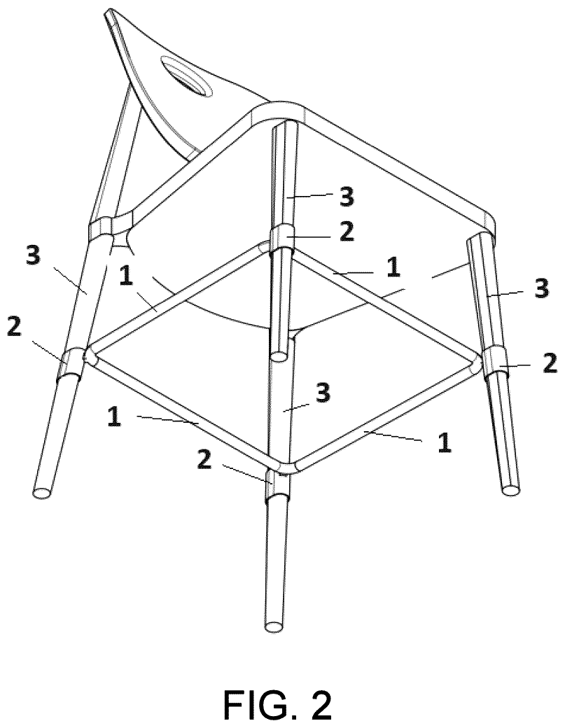

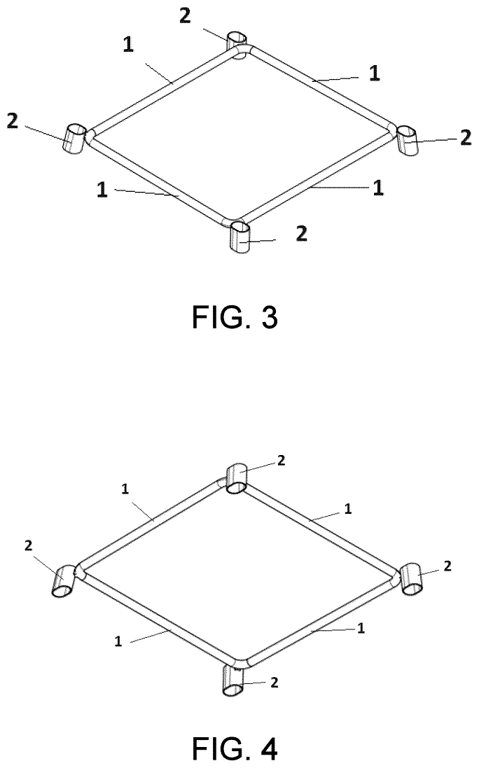

### DETAILED DESCRIPTION OF THE INVENTION

The present model aims at providing a reinforcement support for the legs of furniture pieces such as chairs, beds, tables, cabinets, shelves, among others, in order to provide greater strength to the legs of the piece of furniture, resulting in a longer useful life of the piece and a reduction in much of the instability, thus providing greater safety for the user.

The constructive arrangement of the present model comprises a support (1) preferably with a square-shaped structure, but may also include other shapes such as rectangular, circular, U-shaped or any other shape.

The support (1) is fitted to the legs (3) of the furniture in order to provide reinforcement to the legs and ensure that the same do not wobble when weight is applied to the furniture.

The support can be fitted to the furniture legs by simply inserting the leg (3) of the piece of furniture into the fitting sleeve (2) of the support, located at each of the vertices of the structure of the support (1), which ensures the stability of the furniture. However, optionally, after inserting the legs (3) of the furniture into the fitting sleeves (2) of the support (1), the fitting between the support and the furniture leg can be reinforced by using any means of fastening such as welding, glue, rivets or screws, which penetrate the sleeve (2) of the support (1) and the leg (3), joining both.

Thus, the support (1) connects to the legs (3) of the piece of furniture internally, that is, in such a way as to internally outline the perimeter defined by the furniture legs.

It is also important to mention that, in addition to providing strength to the furniture legs, the constructive arrangement of the present model also has the advantage of allowing the support (1) to be replaced easily.

Obviously, variations in shape, without changing the technical-functional unit, must also be contemplated within the scope of the present utility model. In other words, the support (1) does not necessarily need to have cylindrical edges, which may be prismatic, for example. The same applies to the shape of the fitting sleeves (2) of the support (1).

In addition, the support (1) may also contemplate the absence of one of the edges, resulting in a U-shape.

1. A constructive arrangement applied to a support for reinforcing furniture legs comprising:
a support containing fitting sleeves that fit internally to legs of a piece of furniture.

2. The constructive arrangement applied to a support for reinforcing furniture legs according to claim 1, wherein the support has a square-shaped structure.

3. The constructive arrangement applied to a support for reinforcing furniture legs according to claim 1, wherein the support has a U-, rectangular, circular, or any other shaped structure.

4. The constructive arrangement applied to a support for reinforcing furniture legs according to claim 1, wherein the fitting sleeves are located at each of the vertices of the structure of the support.

5. The constructive arrangement applied to a support for reinforcing furniture legs according to claim 1, wherein the fitting sleeves fit to the legs of the furniture through fastening means.

6. The constructive arrangement applied to a support for reinforcing furniture legs according to claim 5, wherein the fastening means are one of welding, glue, rivets or screws.

7. The constructive arrangement applied to a support for reinforcing furniture legs according to claim 1, wherein the support has cylindrical or prismatic edges.

8. The constructive arrangement applied to a support for reinforcing furniture legs according to claim 1, wherein the fitting sleeves have a cylindrical or prismatic shape.
